(19) United States
(12) Patent Application Publication
(10) Pub. No.: US 2024/0364028 A1
(43) Pub. Date: Oct. 31, 2024

(54) Connector and Connector Assembly

(71) Applicant: Tyco Electronics (Shanghai) Co., Ltd., Shanghai (CN)

(72) Inventors: Hengkang Wu, Dongguan (CN); Xinjie (David) Zhang, Shanghai (CN)

(73) Assignee: Tyco Electronics (Shanghai) Co., Ltd., Shanghai (CN)

(21) Appl. No.: 18/647,423

(22) Filed: Apr. 26, 2024

(30) Foreign Application Priority Data
Apr. 28, 2023 (CN) 202310486465.1

(51) Int. Cl. H01R 12/73; H01R 12/71

(52) U.S. Cl. CPC H01R 12/737; H01R 12/716

(57) ABSTRACT

A connector comprises a housing adapted to be fixed on a circuit board, and a first terminal. The first terminal is arranged in the housing and has an elastic end exposed out of the housing. When the housing is fixed to the circuit board, the elastic end of the first terminal reliably contacts a contact pad on the circuit board under a pressing force applied by the housing.

### CROSS-REFERENCE TO RELATED APPLICATION

This application claims the benefit of Chinese Patent Application No. CN202310486465.1 filed on Apr. 28, 2023, in the State Intellectual Property Office of China, the whole disclosure of which is incorporated herein by reference.

### FIELD OF THE INVENTION

The present invention relates to a connector and a connector assembly including the connector.

### BACKGROUND

In the prior art, for a multifunctional connector with low-speed signal terminals and high-speed signal terminals, the low-speed signal terminals typically need to be connected to a separate plug connector through separate electronic wires and matched with a socket connector on the circuit board through the plug connector to achieve electrical connection between the low-speed signal terminals and the circuit board. The high-speed signal terminals of this multifunctional connector are usually connected to a high-speed cable and transmit high-speed differential signals through the high-speed cable.

In the prior art, due to the need for low-speed signal terminals to be electrically connected to the circuit board through the separate electronic wires, the plug connector and the socket connector, the cost is high, and the electronic wires will occupy space in an electric product, which is not conducive to product miniaturization. At the same time, the electronic wires have wind resistance issues, significantly affecting the heat dissipation capacity of the electric product.

### SUMMARY

According to one embodiment of the present disclosure, a connector comprises a housing adapted to be fixed on a circuit board, and a first terminal. The first terminal is arranged in the housing and has an elastic end exposed outside of the housing. When the housing is fixed to the circuit board, the elastic end of the first terminal reliably contacts a contact pad on the circuit board under a pressing force applied by the housing.

### BRIEF DESCRIPTION OF THE DRAWINGS

The invention will now be described by way of example with reference to the accompanying Figures, of which:

FIG. 1 shows an illustrative perspective view of a connector according to an exemplary embodiment of the present invention when viewed from the rear side;

FIG. 2 shows an illustrative perspective view of a connector according to an exemplary embodiment of the present invention when viewed from the front side;

FIG. 3 shows an illustrative perspective view of a first terminal, a second terminal, and a cable of a connector according to an exemplary embodiment of the present invention when viewed from the rear side;

FIG. 4 shows an illustrative perspective view of a first terminal, a second terminal, and a cable of a connector according to an exemplary embodiment of the present invention when viewed from the front side;

FIG. 5 shows an illustrative perspective view of a connector and a circuit board according to an exemplary embodiment of the present invention, wherein the connector is not yet fixed to the circuit board;

FIG. 6 shows an illustrative perspective view of a connector and a circuit board according to an exemplary embodiment of the present invention, wherein the connector has been fixed to the circuit board;

FIG. 7 shows an illustrative perspective view of a first terminal, a second terminal, and a first holder of a connector according to an exemplary embodiment of the present invention;

FIG. 8 shows an illustrative view of a second holder for holding a second terminal, an electrical connecting member, and a cable according to an exemplary embodiment of the present invention;

FIG. 9 shows an illustrative view of assembling an integral part shown in FIG. 8 into the housing of the connector; and

FIG. 10 shows a molded body formed between the second holder and the housing of the connector shown in FIG. 9.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a connector comprises a housing adapted to be fixed on a circuit board, and a first terminal arranged in the housing and having an elastic end exposed outside of the housing. When the housing is fixed to the circuit board, the elastic end of the first terminal reliably contacts a contact pad on the circuit board under a pressing force applied by the housing.

According to another embodiment, a connector assembly comprises of the above connector, and a circuit board having a contact pad. The housing of the connector is fixed on the circuit board, and the elastic end of the first terminal of the connector is in electrical contact with the contact pad of the circuit board.

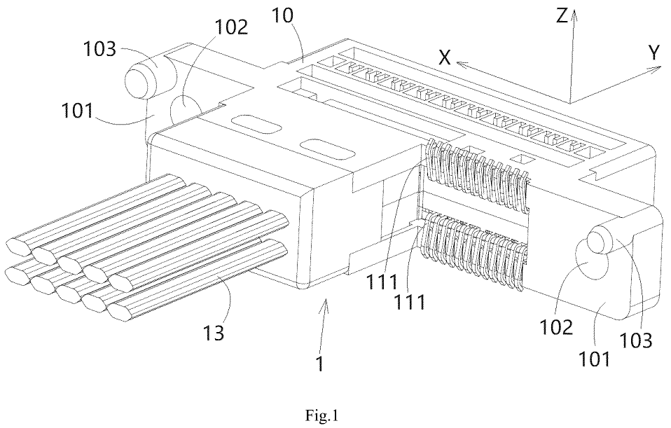

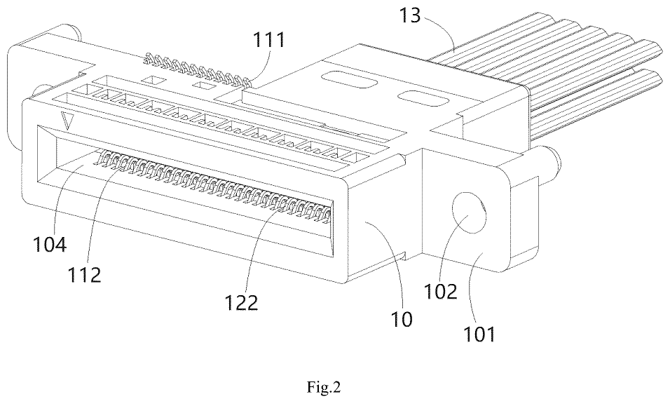

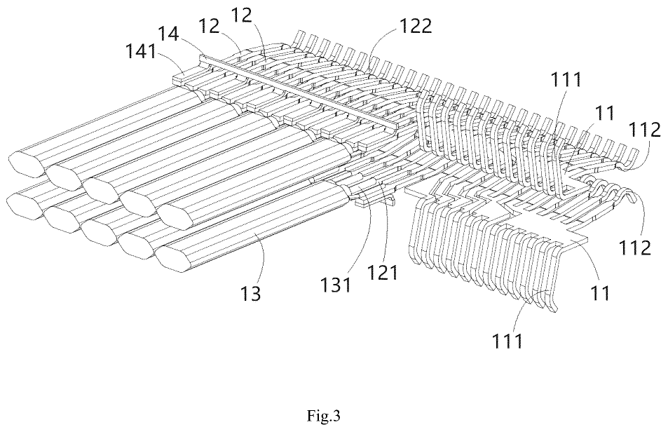

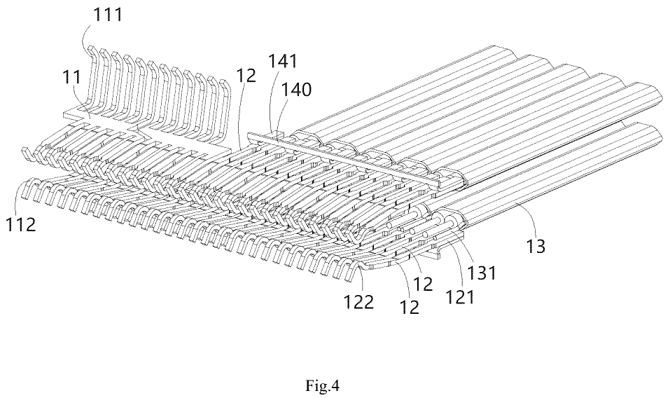

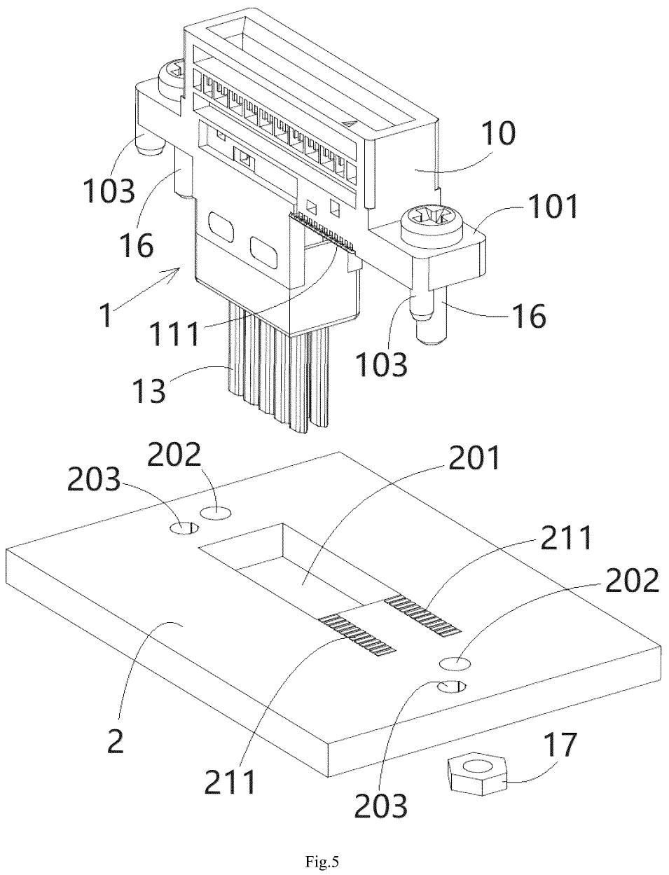

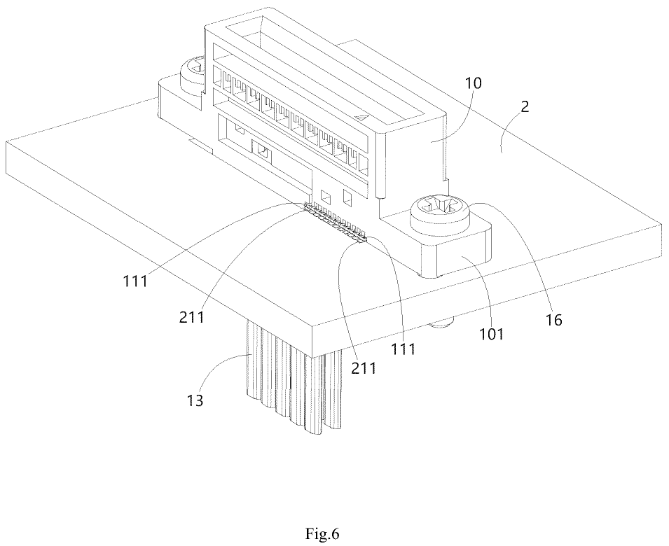

FIG. 1 shows an illustrative perspective view of a connector 1 according to an exemplary embodiment of the present disclosure when viewed from the rear side. FIG. 2 shows an illustrative perspective view of a connector 1 according to an exemplary embodiment of the present disclosure when viewed from the front side. FIG. 3 shows an illustrative perspective view of a first terminal 11, a second terminal 12, and a cable 13 of a connector according to an exemplary embodiment of the present disclosure when viewed from the rear side. FIG. 4 shows an illustrative perspective view of a first terminal 11, a second terminal 12, and a cable 13 of a connector according to an exemplary embodiment of the present disclosure when viewed from the front side. FIG. 5 shows an illustrative perspective view of a connector 1 and a circuit board 2 according to an exemplary embodiment of the present disclosure, wherein the connector 1 is not yet fixed to the circuit board 2. FIG. 6 shows an illustrative perspective view of a connector 1 and a circuit board 2 according to an exemplary embodiment of the present disclosure, wherein the connector 1 has been fixed to the circuit board 2.

As shown in FIGS. 1-6, in an exemplary embodiment of the present invention, the connector 1 is disclosed. This connector 1 is a multifunctional connector that has low speed signal terminals for transmitting ordinary low speed signals and high-speed signal terminals for transmitting high speed differential signals. In the illustrated embodiment, the connector 1 mainly includes a housing 10 and the first terminal 11. The housing 10 is adapted to be fixed to the circuit board 2. The first terminal 11 is arranged in the housing 10 and has an elastic end 111 exposed out of the housing 10.

When the housing 10 is fixed to the circuit board 2, the elastic end 111 of the first terminal 11 reliably contacts the contact pad 211 on the circuit board 2 under the pressing force applied by the housing 10. Therefore, embodiments of the present disclosure can achieve electrical connection between the first terminal 11 and the circuit board 2 without providing separate electronic wires, a plug connector, and a socket connector, saving product costs and improving the heat dissipation capacity of the product.

The housing 10 has opposite front and rear sides in its longitudinal direction Y, and the elastic end 111 of the first terminal 11 is exposed out of the rear side of the housing 10. A slot 104 for inserting a board card is formed on the front side of the housing 10. The first terminal 11 also has a first contact end 112 located in the slot 104, which is used for electrical contact with a first contact, or first golden finger, on the board card.

In the illustrated embodiment, the connector 1 further includes a second terminal 12, which is arranged in the housing 10 and has a connection end 121 and a second contact end 122. The connection end 121 of the second terminal 12 is located in the rear side of the housing 10 and is used for electrical connection with the cable 13. The second contact end 122 of the second terminal 12 is located in the slot 104 on the front side of the housing 10, for electrical contact with a second contact, or second golden finger, on the board card. The elastic end 111 of the first terminal 11 is bent at a predetermined angle relative to the longitudinal direction Y of the housing 10. The connection end 121 of the second terminal 12 linearly extends for a predetermined length along the longitudinal direction Y of the housing 10.

The connector 1 further includes a cable 13. A core wire 131 of the cable 13 is electrically connected to the connection end 121 of the second terminal 12. For example, the core wire 131 of the cable 13 can be soldered or crimped to the connection end 121 of the second terminal 12.

In the illustrated embodiment, the connector 1 includes multiple first terminals 11. The multiple first terminals 11 are arranged in two rows, an upper row, and a lower row. The upper row of first terminals 11 and the lower row of first terminals 11 are opposite in the height direction Z of the housing 10 and close to one side of the housing 10 in the transverse direction X of the housing 10. The connector 1 further includes multiple second terminals 12. The multiple second terminals 12 are arranged in two rows, an upper row, and a lower row. The upper row of second terminals 12 and the lower row of second terminals 12 are opposite in the height direction Z of the housing 10 and close to the other side of the housing 10 in the transverse direction X of the housing 10.

The first contact ends 112 of the upper row of first terminals 11 and the second contact ends 122 of the upper row of second terminals 12 are arranged in a row and evenly spaced along the transverse direction X of the housing 10. The first contact ends 112 of the lower row of first terminals 11 and the second contact ends 122 of the lower row of second terminals 12 are arranged in a row and evenly spaced along the transverse direction X of the housing 10. The elastic end 111 of the first terminal 11 is biased towards one side of the transverse direction X of the housing 10 relative to the first contact end 112 of the first terminal 11, so that the elastic end 111 of the first terminal 11 and the connection end 121 of the second terminal 12 are staggered by a predetermined distance in the transverse direction X of the housing 10.

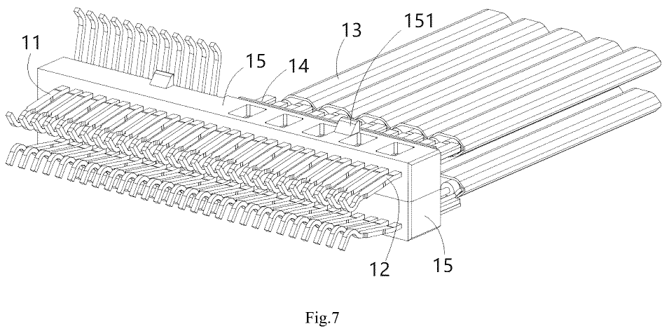

FIG. 7 shows an illustrative perspective view of the first terminal 11, the second terminal 12, and a first holder 15 of a connector 1 according to an exemplary embodiment of the present invention.

As shown in FIGS. 1-7, in the illustrated embodiment, the connector 1 further includes a first holder 15. The first holder 15 is adapted to hold the first terminal 11 and the second terminal 12 together, so that the first terminal 11 and the second terminal 12 can be installed together in the housing 10. In the illustrated embodiment, the first holder 15 is a molded part directly formed on the first terminal 11 and the second terminal 12 through an embedded injection molding process. This can reduce manufacturing costs. In the illustrated embodiments, a protrusion 151 is formed on the first holder 15 and is adapted to engage with a groove in the housing 10 to fix the first holder 15 in the housing 10. Multiple first terminals 11 include a first signal terminal (low-speed signal terminal) and a power terminal, multiple second terminals 12 include a second signal terminal (high-speed differential signal terminal) and a grounding terminal, and the signal transmission rate of the first signal terminal is lower than that of the second signal terminal.

The connector 1 further includes two electrical connecting members 14. Two electrical connecting members 14 are respectively arranged above the upper row of second terminals 12 and below the lower row of second terminals 12. One electrical connecting member 14 located above the upper row of second terminals 12 electrically connects all the grounding terminals in the upper row of second terminals 12 together. The other electrical connecting member 14 located below the lower row of second terminals 12 electrically connects all the grounding terminals in the lower row of second terminals 12 together. In this way, the grounding shielding effect of the connector can be improved, and the transmission quality and stability of the signal can be improved.

The electrical connecting member 14 includes a strip body 140 and multiple toothed parts 141. The strip body 140 extends along the transverse direction X of the housing 10. Multiple toothed parts 141 are connected to one side of the strip body 140 and arranged in a row along the strip body 140. Multiple toothed parts 141 are respectively electrically connected to the connection ends 121 of multiple grounding terminals to electrically connect the multiple grounding terminals together.

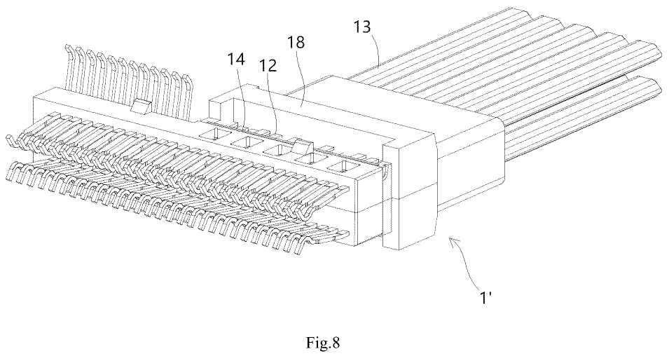

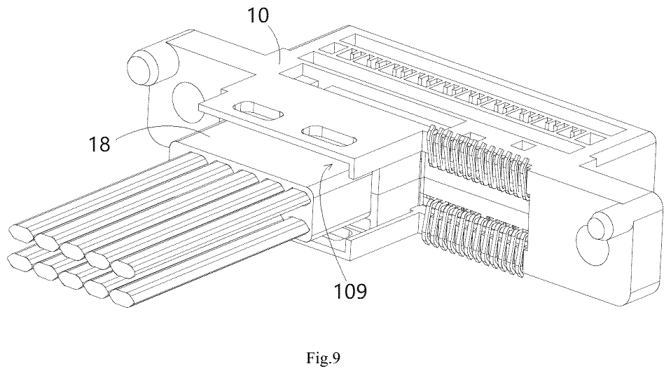

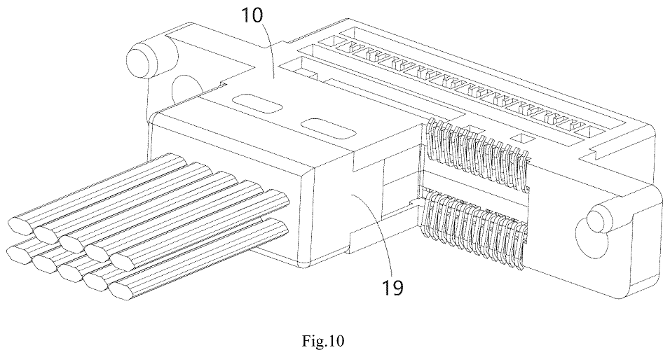

FIG. 8 shows an illustrative view of the second holder 18 for holding the second terminal 12, the electrical connecting member 14, and the cable 13 according to an exemplary embodiment of the present invention. FIG. 9 shows an illustrative view of assembling the integral part 1′ shown in FIG. 8 into the housing 10 of connector 1. FIG. 10 shows the molded body 19 formed between the second holder 18 shown in FIG. 9 and the housing 10 of the connector 1.

As shown in FIGS. 1-8, in the illustrated embodiment, the connector 1 also includes a second holder 18, which is used to hold the second terminal 12, the cable 13, and the electrical connecting member 14 together, so that the second terminal 12, the cable 13, and the electrical connecting member 14 can be installed together in the housing 10. In the illustrated embodiment, the second holder 18 is a molded part directly molded onto the second terminal 12, the cable 13, and the electrical connecting member 14 through an embedded injection molding process. As shown in FIGS. 8 and 9, in the illustrated embodiment, the first terminal 11, the second terminal 12, the cable 13, and the electrical connecting member 14 are held together by the first holder 15 and the second holder 18, forming an integral part 1′ that can be assembled together into the housing 10. Referring generally to FIGS. 1-10, in the illustrated embodiments, the connector 1 further includes a molded body 19, which is formed between the housing 10 and the second holder 18 to seal a gap 109 between the housing 10 and the second holder 18 and to combine the housing 10 and the second holder 18 together.

In another exemplary embodiment of the present invention, a connector assembly is also disclosed. The connector assembly mainly includes the aforementioned connector 1 and a circuit board 2. The circuit board 2 has multiple contact pads 211, which are arranged in two rows for electrical contact with the elastic ends 111 of two rows of first terminals 11. In the illustrated embodiment, the housing 10 of connector 1 is fixed on the circuit board 2, and the elastic end 111 of the first terminal 11 of connector 1 is in electrical contact with the contact pad 211 on the circuit board 2.

The housing 10 has an ear shaped connecting part 101, on which a first connection hole 102 is formed, and a second connection hole 202 corresponding to the first connection hole 102 is formed on the circuit board 2. The connector assembly also includes a bolt 16 and a nut 17. The bolt 16 passes through the first connection hole 102 and the second connection hole 202 and is threaded with the nut 17 to secure the housing 10 to the circuit board 2.

A positioning post 103 is formed on the connecting part 101 of the housing 10, and a positioning hole 203 is formed on the circuit board 2. The positioning post 103 is matched with the positioning hole 203 to position the housing 10 on the circuit board 2. This makes it easier to secure the housing 10 to the circuit board 2. An opening 201 is formed on the circuit board 2 that allows the cable 13 to pass through, and the core wire 131 of the cable 13 is electrically connected to the connection end 121 of the second terminal 12 of the connector 1.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
a housing which adapted to be fixed on a circuit board; and
a first terminal arranged in the housing and having an elastic end exposed outside of the housing, wherein when the housing is fixed to the circuit board, the elastic end of the first terminal is adapted to contact an exposed contact pad on the circuit board under a pressing force applied by the housing.

2. The connector according to claim 1, further comprising a second terminal arranged in the housing and having a connection end and a second contact end, the connection end of the second terminal is located in a rear side of the housing and is adapted to be electrically connected to a cable.

3. The connector according to claim 2, wherein a signal transmission rate of the first terminal is lower than that of the second terminal.

4. The connector according to claim 3, wherein the connector includes multiple first terminals and multiple second terminals, the multiple first terminals including a first signal terminal and a power terminal, the multiple second terminals including a second signal terminal and a grounding terminal.

5. The connector according to claim 2, wherein:
the housing has front and rear sides opposite to each other in a longitudinal direction thereof, the elastic end of the first terminal is exposed outside of the rear side of the housing;
a slot for inserting a board card is formed on the front side of the housing, and the first terminal has a first contact end located in the slot and adapted to electrically contact a first contact on the board card; and
the second contact end of the second terminal is located in a slot on the front side of the housing for electrical contact with a second contact on the board card.

6. The connector according to claim 5, wherein:
the elastic end of the first terminal is bent at a predetermined angle relative to the longitudinal direction of the housing;
the connection end of the second terminal linearly extends for a predetermined length along the longitudinal direction of the housing.

7. The connector according to claim 5, further comprising a cable having core wire electrically connected to the connection end of the second terminal.

8. The connector according to claim 7, wherein:
the connector includes multiple first terminals arranged in an upper row and a lower row; and
the upper row of first terminals and the lower row of first terminals are opposite in a height direction of the housing and are arranged proximate a first side of the housing in a transverse direction of the housing.

9. The connector according to claim 8, wherein:
the connector includes multiple second terminals are arranged in an upper row and a lower row; and
the upper row of second terminals and the lower row of second terminals are opposite in the height direction of the housing and are arranged proximate to a second side of the housing in the transverse direction of the housing.

10. The connector according to claim 9, wherein:
the first contact ends of the upper row of first terminals and the second contact ends of the upper row of second terminals are arranged in a row and are evenly spaced along the transverse direction of the housing;
the first contact ends of the lower row of first terminals and the second contact ends of the lower row of second terminals are arranged in a row and are evenly spaced along the transverse direction of the housing; and
the elastic end of the first terminal is biased towards one side of the housing in the transverse direction of the housing relative to the first contact end of the first terminal, so that the elastic end of the first terminal and the connection end of the second terminal are staggered by a predetermined distance in the transverse direction of the housing.

11. The connector according to claim 9, further comprising a first holder adapted to hold the first terminal and the second terminal together such that the first terminal and the second terminal are capable of being installed together in the housing, wherein the first holder is a molded part directly molded onto the first terminal and the second terminal by an embedded injection molding process.

12. The connector according to claim 11, wherein a protrusion is formed on the first holder and is adapted to engage with a groove in the housing to fix the first holder in the housing.

13. The connector according to claim 9, further comprising two electrical connecting members which are respectively arranged above the upper row of second terminals and below the lower row of second terminals, wherein:
one electrical connecting member located above the upper row of second terminals electrically connects all of the grounding terminals in the upper row of second terminals together; and
the other electrical connecting member located below the lower row of second terminals electrically connects all of the grounding terminals in the lower row of second terminals together.

14. The connector according to claim 13, wherein the electrical connecting member includes:
a strip body extending along the transverse direction of the housing; and
multiple toothed parts connected to one side of the strip body and arranged in a row along the strip body, the multiple toothed parts are electrically connected to the connection ends of the multiple grounding terminals and electrically connect the multiple grounding terminals together.

15. The connector according to claim 13, further comprising a second holder adapted to hold the second terminal, the cable and the electrical connecting member together such that the second terminal, the cable and the electrical connecting member are capable of being installed together in the housing, wherein the second holder is a molded part directly molded onto the second terminal, the cable and the electrical connecting member by an embedded injection molding process.

16. The connector according to claim 15, further comprising a molded body formed between the housing and the second holder to seal a gap between the housing and the second holder and to combine the housing and the second holder together.

17. A connector assembly, comprising:
a connector, including:
a housing adapted to be fixed on a circuit board; and
a first terminal arranged in the housing and having an elastic end exposed out of the housing; and
a circuit board having a contact pad, wherein the housing of the connector is fixed on the circuit board, and the elastic end of the first terminal of the connector is in electrical contact with the contact pad on the circuit board under a pressing force applied by the housing.

18. The connector assembly according to claim 17, wherein:
the housing has a connecting part, a first connecting hole is formed in the connecting part, a second connecting hole corresponding to the first connecting hole is formed in the circuit board; and
the connector assembly further comprises a fastener passing through the first connection hole and the second connection hole and securing the housing to the circuit board.

19. The connector assembly according to claim 18, wherein a positioning post is formed on the connecting part, and a positioning hole is formed in the circuit board, the positioning post corresponding to the positioning hole to locate the housing on the circuit board.

20. The connector assembly according to claim 17, wherein an opening is formed in the circuit board that allows the cable to pass through, and a core wire of the cable is electrically connected to the connection end of the second terminal of the connector.
